(19) United States
(12) Patent Application Publication
(10) Pub. No.: US 2019/0315917 A1
(43) Pub. Date: Oct. 17, 2019

(54) CROSSLINKABLE MATERIALS BASED ON ORGANYLOXYSILANE-TERMINATED POLYMERS

(71) Applicant: Wacker Chemie AG, Munich (DE)

(72) Inventors: Volker STANJEK, Ampfing (DE); Lars ZANDER, Altoetting (DE)

(73) Assignee: Wacker Chemie AG, Munich (DE)

(21) Appl. No.: 16/309,524

(22) PCT Filed: Jun. 28, 2016
(86) PCT No.: PCT/EP2016/065039

§ 371 Date: Dec. 13, 2018

(51) Int. Cl. C08G 65/336; C08L 71/02; C08L 75/04; C08G 77/46; C08L 93/04; C08K 5/00; C08G 18/28; C08G 77/18; C08G 77/54; C08J 3/00; C08J 3/20; C08J 5/12

(52) U.S. Cl. CPC C08G 65/336; C08L 71/02; C08L 75/04; C08G 77/46; C08L 93/04; C08K 5/0025; C08K 3/013; C08G 77/18; C08G 77/54; C08J 3/005; C08J 3/20; C08J 5/124; C08L 2205/03; C08G 18/283

(57) ABSTRACT

Crosslinkable compositions suitable for use as adhesives or sealants contain:
(A) 100 parts by weight of silane-crosslinking polymers (A1) of the formula

R²—O-Z¹-O—CO—NH—(CH₂)—SiRₐ(OR¹)₃₋ₐ (I)

and/or
polymers (A2) of the formula

R⁴—O-Z²-O—CO—NH—(CH₂)₃—Si(OR³)₃ (II),
(B) 0 to 300 parts by weight of silane-crosslinking polymers having at least two end groups of the formula

—SiR⁷_{c}(OR⁸)_{3-c} (III),

and also
(C) 20 to 400 parts by weight of a tackifier resin.

### CROSS REFERENCE TO RELATED APPLICATIONS

This application is the U.S. National Phase of PCT Appln. No. PCT/EP2016/065039 filed Jun. 28, 2016, the disclosure of which is incorporated in its entirety by reference herein.

### BACKGROUND OF THE INVENTION

### 1. Field of the Invention

The invention relates to crosslinkable compositions based on silane-crosslinking prepolymers, to methods for producing them, and to the use thereof as adhesives and sealants.

### 2. Description of the Related Art

Polymer systems which possess reactive alkoxysilyl groups have a long history. On contact with water or atmospheric moisture, these alkoxysilane-terminated polymers are capable, even at room temperature, of undergoing condensation with one another, accompanied by elimination of the alkoxy groups. One of the most important applications of such materials is the production of adhesives and sealants.

Adhesives and sealants based on alkoxysilane-crosslinking polymers, then, exhibit not only good adhesion properties on certain substrates when in the fully cured state, but also exhibit very good mechanical properties, being capable not only of being highly elastic but also of possessing tensile strength. Relative to conventional silicone sealants, moreover, silane-crosslinking systems have the advantages of recoatability and also reduced soiling tendencies. Relative to other reactive adhesive systems such as polyurethane systems, furthermore, they have the advantage of being toxicologically unobjectionable.

There are numerous applications where one-component systems (1K systems) are preferred, curing on contact with atmospheric moisture. One of the decisive advantages of one-component systems is, in particular, their very great ease of application, since in this case there is no need for the user to mix a variety of adhesive components.

A disadvantage of these prior-art systems is, in particular, the low reactivity of the corresponding MS polymers and/or SPUR polymers with respect to moisture, a factor which necessitates aggressive catalysis. Typically, therefore, the mixtures in question include considerable quantities of toxicologically objectionable tin catalysts. This is especially true of silane-crosslinking systems which—like the majority of commercially available MS polymers from Kaneka Corp. (Japan, Osaka)—do not possess 3-trialkoxysilylpropyl groups, instead possessing only the even less reactive 3-methyldialkoxysilylpropyl groups.

An advantage here is the use of what are called α-silane-terminated prepolymers, which possess reactive alkoxysilyl groups connected to an adjacent urethane unit by a methylene spacer. This class of compounds is highly reactive and requires neither tin catalysts nor strong acids or bases in order to achieve high cure rates on air contact. Commercially available α-silane-terminated prepolymers are GENIOSIL® STP-E10 or -E30 from Wacker-Chemie AG.

The great majority of the chain ends of the customary silane-terminated polymers of the kind widely described in the literature possess a crosslinkable silane function and therefore, if based on polymers with linear backbones, contain two silane functions per molecule. For branched polymers, depending on their degree of branching, the number of chain ends is even greater, and they therefore possess even more reactive silane functions per molecule.

These products cure to form compositions having surfaces which are of only low tack or are completely tack-free. Oftentimes, but by no means always, this is a desired feature. Furthermore, the materials in question exhibit comparatively low adhesion to low-energy surfaces, particularly to various plastics such as EPDM (ethylene-propylene-diene rubber), PVC (polyvinyl chloride), PP (polypropylene) or PE (polyethylene).

A certain improvement here is represented by adhesives and sealants which include a certain fraction of polymers which possess not at least two but instead only one silyl group, of the kind described in DE-A 102013216852, for example. Even these materials, however, do not exhibit adequate adhesion on the aforementioned surfaces.

### SUMMARY OF THE INVENTION

An object of the invention, therefore, was to develop adhesives based on silane-terminated prepolymers that overcome the disadvantages of the prior art. These and other objects have been met by compositions (M) comprising

(A) 100 parts by weight of silane-crosslinking polymers, selected from
polymers (A1) of the formula

R²—O-Z¹-O—CO—NH—(CH₂)—SiRₐ(OR¹)₃₋ₐ (I)

and
polymers (A2) of the formula

R⁴—O-Z²-O—CO—NH—(CH₂)₃—Si(OR³)₃ (II),

where
Z¹ denotes divalent polymer radicals which are free from C-bonded hydroxyl groups,
Z² denotes divalent polymer radicals which are free from C-bonded hydroxyl groups,
R may be identical or different and represents a monovalent, SiC-bonded, optionally substituted hydrocarbyl radical,
R¹ may be identical or different and represents hydrogen or monovalent, optionally substituted hydrocarbyl radicals,
R³ may be identical or different and represents hydrogen or monovalent, optionally substituted hydrocarbyl radicals,
R² represents monovalent, optionally substituted hydrocarbyl radicals,
R⁴ represents monovalent, optionally substituted hydrocarbyl radicals, and
a is 0 or 1, preferably 0,
(B) 0 to 300 parts by weight of silane-crosslinking polymers having at least two end groups of the formula

—SiR⁷_{c}(OR⁸)_{3-c} (III),

where
R⁷ may be identical or different and represents monovalent, SiC-bonded, optionally substituted hydrocarbyl radicals,
R⁸ may be identical or different and represents hydrogen or monovalent, optionally substituted hydrocarbyl radicals, and
c is 0, 1 or 2, preferably 0 or 1,
and also
(C) 20 to 400 parts by weight of a tackifier resin.

### DETAILED DESCRIPTION OF THE PREFERRED EMBODIMENTS

The invention is based on the surprising finding that the compositions of the invention comprising components (A) and (C) and also, optionally, component (B), cure on contact with moisture to give solid compositions which exhibit an excellent adhesion profile on low-energy surfaces, especially on plastics such as EPDM, more particularly EPDM roofing membranes, and on PVC, PE and PP films.

Critical to the good properties in particular are the polymers (A) of the invention which possess exactly one reactive silyl group and one nonreactive chain end, so causing them to result on the one hand in the desired, very good adhesion properties while at the same time having no polymers which are not crosslinkable and therefore are migratable.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical, isooctyl radicals, and the 2,2,4-trimethylpentyl radical, nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl, and methylcyclohexyl radicals; alkenyl radicals such as the vinyl, 1-propenyl and 2-propenyl radicals; aryl radicals such as the phenyl, naphthyl, anthryl, and phenanthryl radicals; alkaryl radicals such as the o-, m-, and p-tolyl radicals xylyl radicals, and ethylphenyl radicals; and aralkyl radicals such as the benzyl radical, and the α- and the β-phenylethyl radicals.

Examples of substituted radicals R are haloalkyl radicals such as the 3,3,3-trifluoro-n-propyl radical, the 2,2,2,2′,2′,2′-hexafluoroisopropyl radical, and the heptafluoroisopropyl radical, and haloaryl radicals, such as the o-, m- and p-chlorophenyl radicals.

The radicals R are preferably monovalent hydrocarbyl radicals which are optionally substituted by halogen atoms and have 1 to 6 carbon atoms, more preferably alkyl radicals having 1 or 2 carbon atoms, and most preferably the methyl radical.

Examples of radicals R¹ and R³ are, independently of one another, hydrogen or the examples specified for radical R.

The radicals R¹ and R³ independently of one another are preferably hydrogen or alkyl radicals which are optionally substituted by halogen atoms and have 1 to 10 carbon atoms, more preferably alkyl radicals having 1 or 4 carbon atoms, in particular the methyl or ethyl radical.

Examples of radicals R² and R⁴ are, independently of one another, the examples specified for radical R.

The radicals R² and R⁴ independently of one another are preferably alkyl radicals optionally substituted by halogen atoms and having 1 to 10 carbon atoms, more preferably alkyl radicals having 1 to 6 carbon atoms, and most preferably the methyl, ethyl, n-propyl, or n-butyl radicals.

Examples of polymer radicals Z¹ and Z² are, independently of one another, polyester, polyether, polyurethan, polyalkylene or polyacrylate radicals which are free from C-bonded hydroxyl groups.

The polymer radicals Z¹ and Z² independently of one another are preferably organic polymer radicals which as polymer chains may comprise polyoxyalkylenes such as polyoxyethylene, polyoxypropylene, polyoxybutylene, polyoxytetramethylene, polyoxyethylene-polyoxypropylene copolymer, and polyoxypropylene-polyoxybutylene copolymer; hydrocarbon polymers such as polyisobutylene or copolymers of polyisobutylene with isoprene; polychloroprenes; polyisoprenes; polyurethanes; polyesters; polyamides; polyacrylates; polymethacrylates; vinylpolymer and/or polycarbonates, which are free from C-bonded hydroxyl groups.

With particular preference the radicals Z¹ and Z² are linear polyoxyalkylene radicals which are free from C-bonded hydroxyl groups.

The radicals Z¹ and Z² preferably have a number-average molar mass (number average Mₙ) of at least 2000 g/mol, more preferably at least 3000 g/mol, and most preferably at least 4000 g/mol. They preferably have a number-average molar mass Mₙ of at most 11,000 g/mol, more preferably at most 9000 g/mol, and most preferably at most 7000 g/mol.

The number-average molar mass Mₙ here is determined in the context of the present invention by means of size exclusion chromatography (SEC) against polystyrene standard, in THF, at 60° C., flow rate 1.2 ml/min and detection by RI (refractive index detector), on a Styragel HR3-HR4-HR5-HR5 column set from Waters Corp. USA, with an injection volume of 100 μl.

The polymers (A1) of the formula (I) which can be used as component (A) in accordance with the invention are preferably prepared by reacting polymers of the formula

R²—O-Z¹-OH (IV)

with silanes of the formula

OCN—(CH₂)—SiRₐ(OR¹)₃₋ₐ (V)

where all radicals and indices have one of the definitions stated above.

The polymers (A2) of the formula (II) that can be used as component (A) in accordance with the invention are preferably prepared by reacting polymers of the formula

R⁴—O-Z²-OH (VI)

with silanes of the formula

OCN—(CH₂)₃—Si(OR³)₃ (VII)

where all radicals and indices have one of the definitions stated above.

The reactions in this case are preferably carried out such that there is largely complete silane termination, i.e., a silane termination of at least 90%, more preferably at least 95%, and most preferably at least 98%, of all OH-functional chain ends present.

The compositions (M) of the invention preferably comprise non-silane-functional polymers of the formulae (IV) and (VI) in amounts of at most 15 parts by weight, more preferably of at most 10 parts by weight, and most preferably at most 5 parts by weight, based in each case on 100 parts by weight of component (A).

The polymers (A1) and (A2) here may be prepared by processes of the kind described in principle in EP 1 535 940 B1 or EP 1 896 523 B1, these processes differing only in that monofunctional polymers of the formula (IV) or (VI), respectively, are employed as reactants, and the respective stoichiometries of the reactants are adapted accordingly. Suitable preparation processes are further described in DE-A 102013216852.

The polymers (A1) and (A2) are preferably prepared in the presence of a catalyst (KB). Examples of optionally employed catalysts (KB) are bismuth-containing catalysts, such as catalysts with the trade name Borchi® Kat 22, Borchi® Kat VP 0243 or Borchi® Kat VP 0244 from Borchers GmbH, for example, and also the compounds described below as curing catalysts (D).

If catalysts (KB) are used for the preparation of the polymers (A1), the amounts involved are preferably from 0.001 to 5 parts by weight, more preferably from 0.05 to 1 part by weight, based in each case on 100 parts by weight of the OH-functional polymers of the formulae (IV).

If catalysts (KB) are used for the preparation of the polymers (A2), the amounts involved are from preferably 0.001 to 5 parts by weight, more preferably from 0.05 to 1 part by weight, based in each case on 100 parts by weight of the OH-functional polymers of the formulae (VI).

In the preparation of the polymers (A1) used in accordance with the invention, the reactants of the formulae (IV) and (V) are preferably employed in a quantitative ratio such that 0.9 to 2.0 mol, preferably 0.95 to 1.6 mol, more preferably 1.0 mol to 1.4 mol of isocyanate groups are used per mole of hydroxyl functions.

In the preparation of the polymers (A2) used in accordance with the invention, the reactants of the formulae (VI) and (VII) are preferably employed in a quantitative ratio such that 0.9 to 2.0 mol, preferably 0.95 to 1.6 mol, more preferably 1.0 mol to 1.4 mol of isocyanate groups are used per mole of hydroxyl functions.

The average molecular weights Mₙ of the compounds (A1) and (A2) are preferably each at least 3000 g/mol and preferably at most 8000 g/mol, more preferably at most 7000 g/mol.

The viscosity of the polymers (A1) and (A2) independently of one another is preferably at least 0.2 Pas, more preferably at least 0.5 Pas, and most preferably at least 1 Pas, and preferably at most 10 Pas, more preferably at most 8 Pas, and most preferably at most 5 Pas, measured in each case at 20° C.

The viscosity in the context of the present invention is determined after conditioning to 23° C. with a DV 3 P rotational viscometer from A. Paar (Brookfield system), using spindle 5 at 2.5 rpm in accordance with ISO 2555.

The polymer (A1) which can be employed as component (A) in accordance with the invention preferably comprises linear polyoxypropylenes which are terminated at one chain end in each case with groups of the formula —O—CO—NH—(CH₂)—Si(CH₃)(OCH₃)₂. At the other end, very preferably, these polymers have an alkyl group, such as the sales product GENIOSIL® XM 20, for example, available from Wacker Chemie AG (Munich, DE).

The polymer (A2) which can be employed as component (A) in accordance with the invention preferably comprises linear polyoxypropylenes which are terminated at one chain end in each case with groups of the formula —O—CO—NH—(CH₂)₃—Si(OCH₃)₃. At the other end, very preferably, these polymers have an alkyl group, such as the sales product GENIOSIL® XM 25, for example, available from Wacker Chemie AG (Munich, DE).

Component (A) may comprise exclusively component (A1), exclusively component (A2), or mixtures of components (A1) and (A2).

Employed preferably as component (A) is component (A1) exclusively or component (A2) exclusively.

The components (A1) and (A2) used in accordance with the invention may each comprise only one kind of compound of the formula (I) or (II), respectively, or else mixtures of different kinds of compounds of the formula (I) or (II), respectively.

The compositions (M) of the invention preferably comprise component (A) in concentrations of at most 80 wt %, more preferably at most 70 wt %, and preferably at least 10 wt %, more preferably at least 20 wt %.

Examples of the radicals R⁷ are the examples specified for radical R.

The radical R⁷ preferably comprises monovalent hydrocarbyl radicals which are optionally substituted by halogen atoms and have 1 to 6 carbon atoms, more preferably alkyl radicals having 1 or 2 carbon atoms, most preferably the methyl radical.

Examples of the radicals R⁸ are hydrogen or the examples specified for radical R.

The radical R⁸ more preferably comprises hydrogen or alkyl radicals which are optionally substituted by halogen atoms and have 1 to 10 carbon atoms, more preferably alkyl radicals having 1 to 4 carbon atoms, and most preferably the methyl or ethyl radical.

The optionally employed component (B) preferably comprises polymers which have at least two end groups of the formula (III). In the case of component (B), the number of end groups of the formula (III) per molecule is preferably at most 4.

Component (B) preferably comprises polyesters, polyacrylates, polyoxyalkylenes or polyurethanes which have at least two end groups of the formula (III), more preferably polyurethanes or polyoxyalkylenes which have at least two end groups of the formula (III), and most preferably polyoxyalkylenes which have two or three end groups of the formula (III).

The end groups of component (B), employed optionally in accordance with the invention, are preferably groups of the general formulae

—NH—C(═O)—NR′—(CH₂)_{b}—SiR⁷_{c}(OR⁸)_{3-c} (VIII),

—O—C(═O)—NH—(CH₂)_{b}—SiR⁷_{c}(OR⁸)_{3-c} (IX)

or

—O—(CH₂)_{b}—SiR⁷_{c}(OR⁸)_{3-c} (X),

where
R′ represents a group —CH(COOR″)—CH₂—COOR″ or an optionally substituted hydrocarbyl radical having 1 to 20 carbon atoms, preferably a group —CH(COOR″)—CH₂—COOR″ or a linear, branched or cyclic alkyl group having 1 to 10 carbon atoms,
R″ may be identical or different and represents an optionally substituted hydrocarbyl radical having 1 to 20 carbon atoms, preferably an alkyl group having 1 to 10 carbon atoms, more preferably a methyl, ethyl or propyl radical,
b may be identical or different and is an integer from 1 to 10, preferably 1, 3 or 4, more preferably 1 or 3, more particularly 1,
and all remaining radicals and indices have one of the definitions specified for them above.

Where the compounds (B) comprise polyurethanes, as is preferred, they preferably have at least two end groups selected from

—NH—C(═)—NR′—(CH₂)₃—Si(OCH₃)₃,

—NH—C(═)—NR′—(CH₂)₃—Si(OC₂H₅)₃,

—O—(═O)—NH—(CH₂)₃—Si(OCH₃)₃ and

—O—(═O)—NH—(CH₂)₃—Si(OC₂H₅)₃,

where R′ has one of the definitions stated above.

Where the compounds (B) comprise polyoxyalkylenes, especially polyoxypropylenes, as is particularly preferred, they preferably have at least two end groups selected from

—O—(CH₂)₃—Si(CH₃)(OCH₃)₂,

—O—(CH₂)₃—Si(OCH₃)₃,

—O—C(═O)—NH—(CH₂)₃—Si(OC₂H₅)₃,

—O—C(═O)—NH—CH₂—Si(CH₃)(OC₂H₅)₂,

—O—C(═O)—NH—CH₂—Si(OCH₃)₃,

—O—C(═O)—NH—CH₂—Si(CH₃)(OCH₃)₂ and

—O—C(═O)—NH—(CH₂)₃—Si(OCH₃)₃.

The number-average molecular weights Mₙ of the compounds (B) are preferably at least 400 g/mol, more preferably at least 4000 g/mol, most preferably at least 10,000 g/mol, and preferably at most 30,000 g/mol, more preferably at most 20,000 g/mol, and most preferably at most 19,000 g/mol.

The viscosity of the compounds (B) is preferably at least 0.2 Pas, more preferably at least 1 Pas, and most preferably at least 5 Pas, and preferably at most 700 Pas, more preferably at most 100 Pas, measured in each case at 20° C.

The compounds (B) used in accordance with the invention are commercial products or can be prepared by methods common in chemistry.

The polymers (B) employed optionally in accordance with the invention may be prepared by known processes, such as addition reactions, such as, for example, hydrosilylation, Michael addition, Diels-Alder addition, or reactions between isocyanate-functional compounds with compounds which have isocyanate-reactive groups.

Examples of polymers (B) are the sales products GENIOSIL® STP-E10, GENIOSIL® STP-E15, GENIOSIL® STP-E30, and GENIOSIL® STP-E35 from Wacker Chemie AG (Munich, DE), ST 61, ST 75, and ST 77 from Evonik (Essen, DE), MS Polymers from Kaneka (Japan, Osaka), e.g., S203H, S303H, SAT010, SAX350, SAX400, and 5227, and also SPUR polymers from Momentive (USA, Albany-N.Y.), e.g., SPUR 1050MM, SPUR 1015LM, and SPUR 3100HM.

Based in each case on 100 parts by weight of component (A), the compositions of the invention preferably comprise at least 10 parts by weight, more preferably at least 20 parts by weight, of component (B). Based in each case on 100 parts by weight of component (A), the compositions of the invention preferably comprise at most 250 parts by weight, more preferably at most 200 parts by weight, of component (B).

The tackifier resin (C) used in accordance with the invention may comprise all tackifier resins known to date which are compatible, preferably with component (A) and, where present, with component (B).

Tackifier resin (C) preferably comprises compounds selected from

(C1) phenol-modified terpene resins preferably with a softening point in the range of 110-130° C.,
(C2) hydrocarbon resins preferably with a softening point in the range of 70-120° C.,
(C3) rosins preferably with a softening point in the range of 90-110° C., and
(C4) acrylic ester resins preferably with a softening point in the range from 30-180° C., more preferably with a softening point in the range of 70-120° C.

The softening points of the tackifier resins may be determined in accordance with the ASTM E28 test standard.

The phenol-modified terpene resins (C1) are preferably prepared by polymerization of terpene hydrocarbons and phenol in the presence of a Friedel-Crafts catalyst.

The phenol-modified terpene resins (C1) preferably have number-average molar masses Mₙ of at most 10,000 g/mol, more preferably of at most 2000 g/mol, and most preferably at most 1000 g/mol. The phenol-modified terpene resins (C1) preferably have number-average molar masses Mₙ of at least 100 g/mol, more preferably at least 200 g/mol, and most preferably at least 250 g/mol.

Corresponding products (C1) are obtainable for example under the trade name DERTOPHENE® H150 or DERTOPHENE® T105 from DRT (Dax Cedex, FR). These products have average molar masses Mₙ of 500-650 g/mol.

The hydrocarbon resins (C2) are preferably resins which are prepared

a) by polymerization of methylstyrene, optionally with simultaneous reaction with phenol,
b) by polymerization of unsaturated aliphatic hydrocarbons having typically 5-10 carbon atoms, or by copolymerization of these hydrocarbons with aromatic hydrocarbons, it also being possible for the reaction products to be further grafted with maleic acid derivatives, or
c) by polymerization of terpene hydrocarbons in the presence of Friedel-Crafts catalysts, or
d) are copolymers based on natural terpenes, examples being styrene-terpene or vinyltoluene-terpene copolymers.

The hydrocarbon resins (C2) preferably have number-average molar masses Mₙ of at most 10,000 g/mol, and most preferably at most 2000 g/mol, more particularly of at most 1000 g/mol. The hydrocarbon resins (C2) preferably have number-average molar masses Mₙ of at least 100 g/mol, more preferably at least 200 g/mol, and most preferably at least 250 g/mol.

Corresponding products (C2) are available for example under the trade name NORSOLENE® W110 or NORSOLENE® W80 from TOTAL Cray Valley (Exton, Pa., US). These products have average molar masses Mₙ of about 1000 g/mol and softening points of 110° C. or 80° C.

The rosins (C3) may be selected from natural or modified rosins, examples being rosins from pine wood tar or tung resin, and also derivatives thereof, which may be hydrogenated, dimerized or polymerized products or products modified with mono-, di- or oligoalcohols such as glycerol.

The rosins (C3) preferably have number-average molar masses Mₙ of at most 10,000 g/mol, more preferably at most 3000 g/mol, and most preferably at most 2000 g/mol. The rosins (C3) preferably have number-average molar masses Mₙ of at least 100 g/mol, more preferably at least 200 g/mol, and most preferably at least 250 g/mol.

A corresponding product (C3) is available for example under the trade name SYLVALITE® RE 100 from Arizona Chemical (Jacksonville, Fla., US). This product is a pentaerythritol rosin having an average molar mass Mₙ of about 1700 g/mol.

The acrylic ester resins (C4) are poly(meth)acrylates which are preparable by polymerization or copolymerization of monomeric (meth)acrylic acid and/or monomeric (meth)acrylic acid derivatives, for example from acrylic acid, methacrylic acid, C1-C20 alkyl acrylates and/or C1-C20 alkyl methacrylates, as are widely described in the literature. Preferred monomeric building blocks here include acrylic acid, methacrylic acid, butyl acrylate, 2-ethylhexyl acrylate, and hydroxyethyl acrylate.

In the preparation of the acrylic ester resins (C4) it is also possible for other unsaturated hydrocarbons to be used as comonomers. Likewise possible is the use of block copolymers as component (C4), which in addition to the poly(meth)acrylate chain moiety may also have hydrocarbon chain moieties.

The acrylic ester resins (C4) preferably have number-average molar masses Mₙ of at most 100,000 g/mol, more preferably of at most 20,000 g/mol. The acrylic ester resins (C4) preferably have number-average molar masses Mₙ of at least 200 g/mol, more preferably of at least 400 g/mol, and most preferably of at least 600 g/mol.

The acid number of the acrylic ester resins (C4) is preferably at most 150 mg KOH/g, more preferably at most 100 mg KOH/g, and most preferably 10 to 100 mg KOH/g.

Corresponding products (C4) are available for example under the trade name KOLON® PX95 from Kolon Industries Inc. (Korea, Kwacheon City) or ACRONAL® 4F from BASF (Ludwigshafen, DE).

Based in each case on 100 parts by weight of component (A), the compositions of the invention preferably comprise at least 40 parts by weight, more preferably at least 50 parts by weight, of component (C). Based in each case on 100 parts by weight of component (A), the compositions of the invention preferably comprise at most 300 parts by weight, more preferably at most 250 parts by weight, of component (C).

In addition to the components (A), (B), and (C), the compositions (M) of the invention may also comprise further substances which are different from components (A), (B), and (C), such as, for example, catalysts (D), fillers (E), adhesion promoters (F), water scavengers (G), nonreactive plasticizers (H), additives (I), and adjuvants (J).

The catalysts (D) employed optionally in the compositions (M) of the invention may be any desired catalysts known for compositions which cure by silane condensation, including the catalysts (KB) already described above.

Examples of metal-containing curing catalysts (D) are organotitanium and organotin compounds, examples being titanic esters such as tetrabutyl titanate, tetrapropyl titanate, tetraisopropyl titanate, and titanium tetraacetylacetonate; tin compound such as dibutyltin dilaurate, dibutyltin maleate, dibutyltin diacetate, dibutyltin dioctanoate, dibutyltin acetylacetonate, dibutyltin oxides, and corresponding dioctyltin compounds.

Examples of metal-free curing catalysts (D) are basic compounds such as triethylamine, tributylamine, 1,4-diazabicyclo[2.2.2]octane, 1,5-diazabicyclo[4.3.0]non-5-ene (DEN), 1,8-diazabicyclo[5.4.0]undec-7-ene (DBU), N,N-bis(N,N-dimethyl-2-aminoethyl)methylamine, pentamethylguanidine, tetramethylguanidine, and also other guanidine derivatives, N,N-dimethylcyclohexylamine, N,N-dimethylphenylamine, and N-ethylmorpholinine.

One preferred embodiment of the invention uses aminoalkyl-functional alkoxysilanes as curing catalysts (D), such as, for example, H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, H₂N(CH₂)₂NH(CH₂)₃—Si(OC₂H₅)₂CH₃, H₂N(CH₂)₂NH(CH₂)₂NH(CH₂)₃—Si(OCH₃)₃, H₂N(CH₂)₂NH(CH₂)₂NH(CH₂)₃—Si(OC₂H₅)₃, cyclo-C₆H₁₁NH(CH₂)₃—Si(OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH(CH₂)₃—Si(OC₂H₅)₂CH₃, phenyl-NH(CH₂)₃—Si(OCH₃)₃, phenyl-NH(CH₂)₃—Si(OC₂H₅)₃, phenyl-NH(CH₂)₃—Si(OCH₃)₂CH₃, phenyl-NH(CH₂)₃—Si(OC₂H₅)₂CH₃, HN((CH₂)₃—Si(OCH₃)₃)₂, HN((CH₂)₃—Si(OC₂H₅)₃)₂HN((CH₂)₃—Si(OCH₃)₂CH₃)₂, HN((CH₂)₃—Si(OC₂H₅)₂CH₃)₂, cyclo-C₆H₁₁NH(CH₂)—Si(OCH₃)₃, cyclo-C₆H₁₁NH(CH₂)—Si(OC₂H₅)₃, cyclo-C₆H₁₁NH(CH₂)—Si(OCH₃)₂CH₃, cyclo-C₆H₁₁NH(CH₂)—Si(OC₂H₅)₂CH₃, phenyl-NH(CH₂)—Si(OCH₃)₃, phenyl-NH(CH₂)—Si(OC₂H₅)₃, phenyl-NH(CH₂)—Si(OCH₃)₂CH₃, phenyl-NH(CH₂)—Si(OC₂H₅)₂CH₃, and also their partial hydrolysates, preference being given to H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OC₂H₅)₃, and cyclo-C₆H₁₁NH(CH₂)₃—Si(OCH₃)₂CH₃ or in each case their partial hydrolysates, and particular preference to H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OCH₃)₂CH₃ or in each case their partial hydrolysates.

Likewise employable as catalyst (D) are acidic compounds, such as, for example, phosphoric acid and its esters, toluenesulfonic acid, sulfuric acid, nitric acid, or else organic carboxylic acids, e.g., acetic acid and benzoic acid.

It is possible here to use in each case only one type of a catalyst (D) or else a mixture of two or more catalysts (D).

If the compositions (M) of the invention do comprise catalysts (D), the amounts are preferably 0.01 to 30 parts by weight, more preferably 0.1 to 15 parts by weight, based in each case on 100 parts by weight of constituent (A). The compositions (M) of the invention preferably do comprise catalysts (D).

The fillers (E) optionally employed in the compositions (M) of the invention may be any desired fillers known to date.

Examples of fillers (E) are nonreinforcing fillers, these being fillers preferably having a BET surface area of up to 50 m²/g, such as quartz, diatomaceous earth, calcium silicate, zirconium silicate, talc, kaolin, zeolites, metal oxide powders, such as aluminum, titanium, iron or zinc oxides and/or their mixed oxides, barium sulfate, precipitated and/or ground chalk, which may be either coated or uncoated, gypsum, silicon nitride, silicon carbide, boron nitride, glass powders and plastics powders, such as polyacrylonitrile powders; reinforcing fillers, these being fillers having a BET surface area of more than 50 m²/g, such as pyrogenically prepared silica, precipitated silica, precipitated chalk, carbon black, such as furnace black and acetylene black, and mixed silicon aluminum oxides of high BET surface area; aluminum trihydroxide, fillers in hollow bead form, such as ceramic microbeads, examples being those obtainable under the trade name Zeeospheres™ from 3M Deutschland GmbH of Neuss, DE; elastic polymeric spheres, such as those obtainable under the trade name EXPANCEL® from AKZO NOBEL, Expancel in Sundsvall, Sweden, or glass beads; fibrous fillers, such as asbestos and also polymeric fibers. Said fillers may have been hydrophobized, by treatment for example with organosilanes and/or organosiloxanes or with stearic acid, or by etherification of hydroxyl groups to alkoxy groups.

The fillers (E) employed optionally are preferably ground and/or precipitated chalk, which may be either coated or uncoated, talc, aluminum trihydroxide, and silica, particular preference being given to calcium carbonate and aluminum trihydroxide. Preferred calcium carbonate grades are ground or precipitated and optionally surface-treated with fatty acids such as stearic acid or its salts. The preferred silica is preferably pyrogenic silica.

Fillers (E) optionally employed preferably have a moisture content of preferably below 1 wt %, more preferably of below 0.5 wt %.

If the compositions (M) of the invention do comprise fillers (E), the amounts involved are preferably 10 to 1000 parts by weight, more preferably 50 to 500 parts by weight, and most preferably 70 to 200 parts by weight, based in each case on 100 parts by weight of constituent (A).

The adhesion promoters (F) optionally employed in the compositions (M) of the invention may be any desired adhesion promoters which have been described to date for systems which cure by silane condensation, and which are different from components (A) to (D). Preferably they are monomeric molecules or are silanes oligomerized via siloxane bonds and different from component (D).

Preferred examples of adhesion promoters (F) are epoxysilanes such as glycidyloxypropyltrimethoxysilanes, glycidyloxypropylmethyldimethoxysilane, glycidyloxypropyltriethoxysilane or glycidyloxypropylmethyldiethoxysilane, 2-(3-triethoxysilylpropyl)maleic anhydride, N-(3-trimethoxysilylpropyl)urea, N-(3-triethoxysilylpropyl)urea, N-(trimethoxysilylmethyl)urea, N-(methyldimethoxysilylmethyl)urea, N-(3-triethoxysilylmethyl)urea, N-(3-methyldiethoxysilylmethyl) urea, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, 3-methacryloyloxypropyltrimethoxysilane, methacryloyloxymethyltrimethoxysilane, methacryloyloxymethylmethyldimethoxysilane, methacryloyloxymethyltriethoxysilane, methacryloyloxymethylmethyldiethoxysilane, 3-acryloyloxypropyltrimethoxysilane, acryloyloxymethyltrimethoxysilane, acryloyloxymethylmethyldimethoxysilanes, acryloyloxymethyltriethoxysilane, and acryloyloxymethylmethyldiethoxysilane, and also their partial condensates.

If the compositions (M) of the invention do comprise adhesion promoters (F), the amounts are preferably 0.5 to 30 parts by weight, more preferably 1 to 10 parts by weight, based in each case on 100 parts by weight of component (A).

The aminoalkylsilanes described above as preferred catalysts (D) may also serve as adhesion promoters. If the compositions of the invention do comprise amino compounds (D), it is possible to do without the addition of additional adhesion promoters (F) and/or to reduce the amount of component (F).

The water scavengers (G) optionally employed in the compositions (M) of the invention may be any desired water scavengers described for systems which cure by silane condensation.

Examples of water scavengers (G) are silanes such as vinyltrimethoxysilane, vinyltriethoxysilane, vinylmethyldimethoxysilane, O-methylcarbamatomethylmethyldimethoxysilane, O-methylcarbamatomethyltrimethoxysilane, O-ethylcarbamatomethylmethyldiethoxysilane, and O-ethylcarbamatomethyltriethoxysilane, and/or their partial condensates, and also orthoesters, such as 1,1,1-trimethoxyethane, 1,1,1-triethoxyethane, trimethoxymethane, and triethoxymethane.

If the compositions (M) of the invention do comprise water scavengers (G), the amounts are preferably 0.5 to 30 parts by weight, more preferably 1 to 20 parts by weight, based in each case on 100 parts by weight of component (A). The compositions (M) of the invention preferably comprise water scavengers (G).

The nonreactive plasticizers (H) optionally employed in the compositions (M) of the invention may be any desired plasticizers known to date and typical for silane-crosslinking systems.

Examples of nonreactive plasticizers (H) are phthalic esters (e.g., dioctyl phthalate, diisooctyl phthalate, and diundecyl phthalate), perhydrogenated phthalic esters (e.g., diisononyl 1,2-cyclohexanedicarboxylate and dioctyl 1,2-cyclohexanedicarboxylate), adipic esters (e.g., dioctyl adipate), benzoic esters, glycol esters, esters of saturated alkanediols (e.g., 2,2,4-trimethyl-1,3-pentanediol monoisobutyrates and 2,2,4-trimethyl-1,3-pentanediol diisobutyrates), phosphoric esters, sulfonic esters, polyesters, polyethers (e.g., polyethylene glycols and polypropylene glycols having molar masses Mₙ of preferably 400 to 10,000 g/mol), polystyrenes, polybutadienes, polyisobutylenes, paraffinic hydrocarbons, and branched hydrocarbons of high molecular mass.

If the compositions (M) of the invention do comprise nonreactive plasticizers (H), the amounts are preferably 0.01 to 100 parts by weight, based on 100 parts by weight of component (A). The compositions (M) of the invention preferably comprise no nonreactive plasticizers (H).

The additives (I) optionally employed in the compositions (M) of the invention may be any desired additives known to date and typical for silane-crosslinking systems.

The additives (I) optionally employed in accordance with the invention are preferably antioxidants, UV stabilizers such as those known as HALS compounds (HALS =hindered amine light stabilizers), for example, fungicides, or pigments.

If the compositions (M) of the invention do comprise additives (I), the amounts are preferably 0.01 to 30 parts by weight, more preferably 0.1 to 10 parts by weight, based in each case on 100 parts by weight of component (A). The compositions (M) of the invention preferably do comprise additives (I).

The adjuvants (J) optionally employed in accordance with the invention are preferably tetraalkoxysilanes, e.g., tetraethoxysilane and/or partial condensates thereof, reactive plasticizers, rheological additives, flame retardants, organic solvents, or non-silane-functional polymers, more particularly those of the formulae (IV) and (VI).

Preferred reactive plasticizers (J) are compounds which contain alkyl chains having 6 to 40 carbon atoms and possess a group which is reactive toward the compounds (A), or organic polymers having precisely one reactive silyl group but not conforming to the formulae (I) or (II).

Examples of reactive plasticizers (J) are isooctyltrimethoxysilane, isooctyltriethoxysilane, N-octyltrimethoxysilane, N-octyltriethoxysilane, decyltrimethoxysilanes, decyltriethoxysilane, dodecyltrimethoxysiloxane, dodecyltriethoxysilane, tetradecyltrimethoxysiloxane, tetradecyltriethoxysilane, hexadecyltrimethoxysilane, and hexadecyltriethoxysilane, and polymers functionalized with a group of the formulae O—(CH₂)₃—Si(CH₃)OCH₃)₂ or —O—(CH₂)₃—Si(OCH₃)₃, more particularly polyurethanes or polyoxypropylenes functionalized with a group of the formulae O—(CH₂)₃—Si(CH₃)(OCH₃)₂ or —O—(CH₂)₂)₃—Si(OCH₃)₃.

The rheological additives (J) are preferably polyamide waxes, hydrogenated castor oils, or stearates.

Examples of organic solvents (J) are low molecular mass ethers, esters, ketones, aromatic and aliphatic, and also optionally halogen-containing, hydrocarbons and alcohols, the latter being preferred.

With preference no organic solvents (J) are added to the compositions (M) of the invention.

The compositions (M) of the invention preferably comprise no non-silane-functional organic polymers (J) which are different from the polymers of the formulae (IV) and (VI). If the compositions (M) do comprise polymers of the formulae (IV) and (VI), the amounts are preferably less than 1 wt %, more preferably less than 0.5 wt %.

If the compositions (M) of the invention do comprise one or more components (J), the amounts in each case are preferably 0.5 to 200 parts by weight, more preferably 1 to 100 parts by weight, most preferably 2 to 70 parts by weight, based in each case on 100 parts by weight of component (A). The compositions (M) of the invention preferably comprise no component (J).

The compositions (M) of the invention preferably comprise migratable fractions, i.e., noncrosslinkable fractions, such as non-silane-functional catalysts (D), nonreactive plasticizers (H), nonreactive additives (I) or nonreactive adjuvants (J), in amounts of at most 30 parts by weight, most preferably in amounts of at most 20 parts by weight, more particularly of at most 10 parts by weight. With particular preference the compositions (M) of the invention comprise no nonreactive plasticizers (H).

The compositions (M) of the invention preferably comprise no constituents other than components (A) to (J).

With regard to the components employed in accordance with the invention, there may be in each case one kind of such a component or else a mixture of at least two kinds of a respective component.

The compositions (M) of the invention are preferably those comprising

(A) 100 parts by weight of polymers selected from polymers (A1) and (A2),
(B) 10 to 300 parts by weight of silane-crosslinking polymers having at least two end groups of the formula (III),
(C) 20 to 400 parts by weight of a tackifier resin,
optionally (D) catalysts,
optionally (E) fillers,
optionally (F) adhesion promoters,
optionally (G) water scavengers,
optionally (H) nonreactive plasticizers,
optionally (I) additives, and
optionally (J) adjuvants.

The compositions (M) of the invention are more preferably those comprising

(A) 100 parts by weight of polymers selected from polymers (A1) and (A2),
(B) 20 to 200 parts by weight of silane-crosslinking polymers having at least two end groups of the formula (III),
(C) 40 to 300 parts by weight of a tackifier resin,
(D) 0.1 to 30 parts by weight of catalysts,
optionally (E) fillers,
optionally (F) adhesion promoters,
optionally (G) water scavengers,
optionally (H) nonreactive plasticizers,
optionally (I) additives, and
optionally (J) adjuvants.

The compositions (M) of the invention are more particularly those comprising

(A) 100 parts by weight of polymers selected from polymers (A1) and (A2),
(B) 20 to 200 parts by weight of silane-crosslinking polymers having at least two end groups of the formula (III),
(C) 40 to 300 parts by weight of a tackifier resin,
(D) 0.1 to 30 parts by weight of catalysts, optionally (E) fillers,
optionally (F) adhesion promoters,
(G) 0.5 to 30 parts by weight of water scavengers
optionally (H) nonreactive plasticizers,
optionally (I) additives, and
optionally (J) adjuvants.

The compositions (M) of the invention are preferably formulations having viscosities of 500 to 1,000,000 mPas, more preferably 1000 to 500,000 mPas, most preferably 5000 to 100,000 mPas, in each case at 25° C.

The compositions (M) of the invention are moisture-curing, meaning that they preferably are liquid or pastelike compositions which cure on contact with water and/or atmospheric moisture.

The compositions (M) of the invention may be produced by any desired and conventional way, such as, for instance, by methods and mixing techniques of the kind customary in the production of moisture-curing compositions.

A further subject of the present invention is a method for producing the compositions (M) of the invention by mixing the individual components in any order.

In the course of such production, if catalyst (D) is being used, it is preferably added only at the end of the mixing operation.

This mixing may take place at room temperature, i.e., at temperatures between 0 and 30° C., and under the pressure of the surrounding atmosphere, in other words about 900 to 1100 hPa. Preferably, however, mixing takes place at higher temperatures, as for example at temperatures in the range from 30 to 130° C., at which component (C) is in a melted state. It is possible, furthermore, to carry out mixing occasionally or continually under reduced pressure, such as at 30 to 500 hPa absolute pressure, for example, in order to remove volatile compounds and/or air.

The mixing of the invention preferably takes place in the absence of moisture. Brief periods of air contact are, however, generally possible, and therefore, in general, no costly and inconvenient inert-gas technology is needed in the production operation.

The method of the invention may be carried out continuously or discontinuously.

The compositions (M) of the invention are preferably one-component compositions which can be stored in the absence of water and which on ingress of water are crosslinkable at room temperature. The compositions (M) of the invention may, however, also be part of two-component crosslinking systems, in which OH-containing compounds, such as water, are added in a second component.

The usual water content of the air is sufficient for the crosslinking of the compositions (M) of the invention. The compositions (M) of the invention are preferably crosslinked at room temperature. Crosslinking may alternatively be carried out, if desired, at temperatures higher or lower than room temperature, as for example at −5° to 15° C. or at 30° to 50° C., and/or by means of water concentrations which exceed the normal water content of the air.

The crosslinking is carried out preferably under a pressure of 100 to 1100 hPa, more preferably under the pressure of the surrounding atmosphere, in other words about 900 to 1100 hPa.

A further subject of the invention are shaped articles produced by crosslinking the compositions (M) of the invention and/or compositions (M) produced in accordance with the invention.

The shaped articles of the invention are preferably coatings, more particularly layers of adhesives between two substrates.

The compositions (M) of the invention may be employed for any purposes for which crosslinkable compositions based on organosilicon compounds have also been employed to date, preferably as adhesives or sealants, more preferably as adhesives for the bonding of substrates, where at least one of the substrates to be bonded has a low-energy surface. Examples would be the adhesive bonding of plastics such as EPDM, more particularly EPDM roofing membranes, PVC, PE, and PP.

Substrates having a low-energy surface for the purposes of this invention are substrates, preferably plastics, having a critical surface energy of not more than 60 mN/m, more preferably of 50 mN/m at most. Examples of materials having low-energy surfaces are polyethylene (PE), polypropylene (PP), polytetrafluoroethylene (PTFE), polymethyl methacrylate (PMMA), polyvinyl chloride (PVC), or polyethylene terephthalate (PET).

A further subject of the invention is a method for adhesively bonding substrates, wherein the composition (M) of the invention is applied to the surface of at least one substrate, this surface is then brought into contact with the second substrate to be bonded, and the composition (M) is subsequently caused to crosslink.

A further subject of the invention is a method for adhesively bonding substrates, wherein the composition (M) of the invention is applied to the surface of at least one substrate and caused to crosslink, and this coated surface is then brought into contact with the second substrate to be bonded.

Preferred examples of substrates which can be bonded in accordance with the invention are plastics such as EPDM, PVC, PE, and PP, but also concrete, mineral substrates, metals, glass, ceramic, painted surfaces, or wood. The materials bonded to one another may be either identical or else different materials.

The compositions (M) of the invention possess the advantage that they are easy to produce.

Furthermore, the compositions (M) of the invention have the advantage that they exhibit good adhesion particularly on low-energy surfaces such as the abovementioned plastics.

The compositions (M) of the invention have the advantage of being distinguished by very high storage stability and high crosslinking rate.

Furthermore, the crosslinkable compositions (M) of the invention have the advantage that they are easy to process.

In the examples described below, all viscosity figures are based on a temperature of 25° C. Unless otherwise indicated, the examples below are carried out under a pressure of the surrounding atmosphere, in other words about 1000 hPa, and at room temperature, in other words at about 23° C., or at a temperature which comes about when the reactants are combined at room temperature without additional heating or cooling, and also at a relative atmospheric humidity of approximately 50%.

Furthermore, all data in parts and percentages are by weight unless otherwise indicated.

### Inventive Example 1

### Production of an Adhesive Formulation

In a 500 ml reaction vessel with stirring, cooling, and heating facilities, 97.2 g of a phenol-modified terpene resin having an average molar mass Mₙ of 500 g/mol (available commercially under the name DERTOPHENE® T105 from DRT, Dax Cedex, FR) are melted at 120° C.

Subsequently, at this temperature, 48.4 g of a polypropylene glycol with silane termination at one end and with an average molar mass Mₙ of 5000 g/mol, having a butyl end group and an end group of the formula —O—C(═O)—NH—(CH₂)₃—Si(OCH₃)₃ (available commercially under the name GENIOSIL® XM 25 from Wacker Chemie AG, Munich, DE), 48.4 g of a polypropylene glycol having silane termination at both ends and having an average molar mass Mₙ of 12,000 g/mol and end groups of the formula —O—C(═O)—NH—CH₂—Si(CH₃)(OCH₃)₂ (available commercially under the name GENIOSIL® STP-E10 from Wacker Chemie AG, Munich, DE), 4 g of vinyltrimethoxysilane, 2 g of N-(2-aminoethyl)-3-aminopropyltrimethoxysilane, and 1.0 g of a stabilizer mixture (mixture available commercially under the name TINUVIN® B 75 from BASF SE, Germany, of 20% Irganox® 1135 (CAS No. 125643-61-0), 40% Tinuvin® 571 (CAS No.

23328-53-2), and 40% Tinuvin® 765 (CAS No. 41556-26-7)) are added and incorporated homogeneously by stirring.

The composition thus obtained is cooled down and dispensed into 310 ml PE cartridges, where it is stored at 20° C. for 24 hours prior to investigation.

### Inventive Example 2

### Production of an Adhesive Formulation

The procedure is as described in inventive example 1, but using, instead of 48.4 g of GENIOSIL® XM 25, the same amount of a polypropylene glycol which is silane-terminated at one end and has an average molar mass Mₙ of 5000 g/mol, and has a butyl end group and an end group of the formula —O—C(═O)—NH—(CH₂)—Si(CH₃)(OCH₃)₂ (available commercially under the name GENIOSIL® XM 20 from Wacker Chemie AG, Munich, DE).

The composition thus obtained is cooled down and dispensed into 310 ml PE cartridges, where it is stored at 20° C. for 24 hours prior to investigation.

### Inventive Example 3

### Production of an Adhesive Formulation

The procedure is as described in inventive example 2, but the mixture is admixed not with 2 g of N-(2-aminoethyl)-3-aminopropyltrimethoxysilane but instead with 0.4 g of 1,8-diazabicyclo[5.4.0]undec-7-ene (DBU).

The composition thus obtained is cooled down and dispensed into 310 ml PE cartridges, where it is stored at 20° C. for 24 hours prior to investigation.

### Comparative Example 1

### Production of an Adhesive Formulation

The procedure is as described in inventive example 1, but using, instead of 48.4 g of GENIOSIL® XM 25 and 48.4 g of GENIOSIL® STP-E10, 96.8 g of GENIOSIL® STP-E10.

The composition thus obtained is cooled down and dispensed into 310 ml PE cartridges, where it is stored at 20° C. for 24 hours prior to investigation.

### Comparative Example 2

### Production of an Adhesive Formulation

The procedure is as described in inventive example 1, but using, instead of 48.4 g of GENIOSIL® XM 25, the same amount of a linear, OH-terminated polypropylene glycol having an average molar mass Mₙ of 2000 g/mol.

The composition thus obtained is cooled down and dispensed into 310 ml PE cartridges, where it is stored at 20° C. for 24 hours prior to investigation.

### Comparative Example 3

### Production of an Adhesive Formulation

96.8 g of GENIOSIL® XM 25 are mixed in a laboratory planetary mixer from PC-Laborsystem, equipped with two cross-arm mixers, at about 25° C. with 96.8 g of GENIOSIL® STP-E10, 4 g of vinyltrimethoxysilane, and 2 g of N-(2-aminoethyl)-3-aminopropyltrimethoxysilane at 200 rpm for 1 minute. The mixture is subsequently homogenized and stirred to remove bubbles for 1 minute at 200 rpm under a partial vacuum (about 100 mbar).

The composition thus obtained is cooled down and dispensed into 310 ml PE cartridges, where it is stored at 20° C. for 24 hours prior to investigation.

### Example 4

### Determination of Property Profiles of the Adhesives Produced

An EPDM film is cleaned with ethanol, left to dry, and then cut into strips each 10 cm in length and 2 cm in width. Thereafter, 3 of these strips in each case are coated, starting from one end and over a length of 7 cm, with in each case one of the adhesive formulations from inventive examples 1 to 3 and, respectively, comparative examples 1 to 3. A region 3 cm in length at one end of the strips therefore remains free. The thickness of the applied layer of adhesive in all cases is 200 μm.

The film strips partially coated in the manner described are subsequently bonded to an uncoated EPDM film strip of the same size, the two strips being placed congruently one above the other and being weighted overnight with a plate weighing 1 kg. The common bond area is therefore 7×2 cm, bordered by an area measuring 3×2 cm in which the two film strips lie one above the other without bonding.

The films thus bonded are stored under standard conditions (23° C. and 50% relative humidity) for 7 days.

The unbonded film ends are then parted and clamped into a materials testing machine Z010 from Zwick. A measurement is made of the force required to pull the bonded films apart. The measurements obtained are found in table 1.

TABLE 1

| | Required tensile force (average from |
|---|---|
| Formulation | 3 measurements) [N] |
| Inventive example 1 | 2.2 |
| Inventive example 2 | 3.5 |
| Inventive example 3 | 3.1 |
| Comparative example 1 | 1.4 |
| Comparative example 2 | 0.9 |
| Comparative example 3 | 1.5 |

1.-11. (canceled)

12. A composition, comprising:
(A) 100 parts by weight of one or more silane-crosslinking polymers (A1) of the formula
R²—O-Z¹-O—CO—NH—(CH₂)—SiRₐ(OR¹)₃₋ₐ (I)
and/or
polymers (A2) of the formula
R⁴—O-Z²-O—CO—NH—(CH₂)₃—Si(OR³)₃ (II),
where
Z¹ denotes divalent polymer radicals which are free from C-bonded hydroxyl groups,
Z² denotes divalent polymer radicals which are free from C-bonded hydroxyl groups,
R are identical or different and represent monovalent, SiC-bonded, optionally substituted hydrocarbyl radicals,
R¹ are identical or different and represent hydrogen or monovalent, optionally substituted hydrocarbyl radicals,
R³ are identical or different and represent hydrogen or monovalent, optionally substituted hydrocarbyl radicals,
R² are identical or different and represent monovalent, optionally substituted hydrocarbyl radicals,
R⁴ are identical or different and represent monovalent, optionally substituted hydrocarbyl radicals, and
a is 0 or 1,
(B) 0 to 300 parts by weight of one or more silane-crosslinking polymers having at least two end groups of the formula
—SiR⁷_{c}(OR⁸)_{3-c} (III),
where
R⁷ are identical or different and represent monovalent, SiC-bonded, optionally substituted hydrocarbyl radicals,
R⁸ are identical or different and represents hydrogen or monovalent, optionally substituted hydrocarbyl radicals, and
c is 0, 1 or 2,
and also
(C) 20 to 400 parts by weight of a tackifier resin, wherein tackifier resin (C) comprises at least one compound selected from the group consisting of
(C1) phenol-modified terpene resins,
(C2) hydrocarbon resins,
(C3) rosins,
(C4) acrylic ester resins, and
mixtures thereof.

13. The composition of claim 12, wherein the radicals Z¹ and Z² are linear polyoxyalkylene radicals which are free from C-bonded hydroxyl groups.

14. The composition of claim 12, wherein the radicals R² and R⁴ independently of one another are alkyl radicals optionally substituted by halogen atoms and having 1 to 10 carbon atoms.

15. The composition of claim 13, wherein the radicals R² and R⁴ independently of one another are alkyl radicals optionally substituted by halogen atoms and having 1 to 10 carbon atoms.

16. The composition of claim 12, comprising component (B) in amounts of 10 to 300 parts by weight.

17. The composition of claim 13, comprising component (B) in amounts of 10 to 300 parts by weight.

18. The composition of claim 12, further comprising at least one water scavenger (G).

19. The composition of claim 12, comprising:
(A) 100 parts by weight of polymers (A1) and/or (A2),
(B) 20 to 200 parts by weight of silane-crosslinking polymers having at least two end groups of the formula (III),
(C) 40 to 300 parts by weight of a tackifier resin,
(D) 0.1 to 30 parts by weight of catalysts,
optionally (E) fillers,
optionally (F) adhesion promoters,
(G) 0.5 to 30 parts by weight of water scavengers,
optionally (H) nonreactive plasticizers,
optionally (I) additives, and
optionally (J) adjuvants.

20. A method for producing a composition of claim 12, comprising mixing the individual components in any order.

21. A shaped article produced by crosslinking a composition of claim 12.

22. A shaped article produced by crosslinking a composition produced by the method of claim 20.

23. A method for adhesively bonding substrates, comprising applying a composition of claim 12 to the surface of at least one substrate, bringing this surface into contact with a second substrate to be bonded, and crosslinking the composition.

24. A method for adhesively bonding substrates, comprising applying a composition of claim 12, to the surface of at least one substrate, crosslinking the composition to form a coated surface, and then bringing this coated surface into contact with a second substrate to be bonded.
